(19) United States
(12) Patent Application Publication
(10) Pub. No.: US 2011/0160952 A1
(43) Pub. Date: Jun. 30, 2011

(54) Method for Entering Data In at Least Two Control Devices of a Motor Vehicle

(75) Inventors: Roland Thomas, Otterfing (DE); Anton Negele, Starnberg (DE)

(73) Assignee: Bayerische Motoren Werke Aktiengesellschaft, Muenchen (DE)

(21) Appl. No.: 13/015,760

(22) Filed: Jan. 28, 2011

Related U.S. Application Data
(63) Continuation of application No. PCT/EP2009/004813, filed on Jul. 3, 2009.

(30) Foreign Application Priority Data
Jul. 30, 2008 (DE) 10 2008 035 557.7

(51) Int. Cl. G06F 17/00

(52) U.S. Cl. 701/33; 701/1

(57) ABSTRACT

A method for entering data into at least a first and a second control device of a motor vehicle is provided. Each of the first and the second control device is provided with a sequencing control that has a reversible deactivation state, a programming mode, and an operating mode with operating functions. The first and the second control device are each put into the deactivation state, during which the execution of operating functions of the operating mode is prevented, preferably at least to a large extent. The first and the second control device are each put into the programming mode, during which the reversible deactivation state of each control device is maintained. The deactivation state of all control devices will be canceled after the respective data have been entered into all control devices in the programming mode.

### CROSS-REFERENCE TO RELATED APPLICATIONS

This application is a continuation of PCT International Application No. PCT/EP2009/004813, filed Jul. 3, 2009, which claims priority under 35 U.S.C. §119 from German Patent Application No. DE 10 2008 035 557.7, filed Jul. 30, 2008, the entire disclosures of which are herein expressly incorporated by reference.

### BACKGROUND AND SUMMARY OF THE INVENTION

Methods consistent with the invention relate to entering data, such as a sequencing control, into at least a first and a second control device of a motor vehicle.

Between 50 and 70 control devices are installed in modern vehicles, whose Flash-E-PROM memory can be updated by way of an onboard diagnostic (OBD) connection and the vehicle-internal on-board network. This reprogramming is also known by the name of “flashing”. For this purpose, a programming system (“tester”) is connected with the vehicle by way of a vehicle access, such as the OBD access.

Within the scope of programming an overall vehicle, the tester executes the programming of the overall vehicle, one control device after another corresponding to its transaction list, or the tester loads so many control devices in a parallel manner as transmission channels are available to it. State 1 software is installed on all control devices of this on-board network before the start of the programming. In a first operating step, the tester transmits the software of the overall packet 2 matching a control device A into the control device A. When the control device A is subsequently restarted (all other control devices in the onboard network have not yet been provided with a new software at this point in time), control device A will already execute the newly installed software. This results in errors because of the inconsistent software state, with software state 2 on control device A and software state 1 on control device B, affecting the safety of the system. Further, each spontaneous restart of a control device in the on-board network impairs the programming of the other control devices, affecting the performance of the system.

In particular, it is an object of the invention to provide a method according to which the control devices of a motor vehicle can be provided with updated data or updated sequencing controls in an accelerated manner.

An aspect of the invention includes improving a related method for the entering of data, particularly a sequencing control, in at least a first and a second control device of a motor vehicle by the following steps. According to an aspect of the invention, the first and the second control device are each provided with a sequencing control which has a reversible deactivation state, a programming mode and an operating mode with operating functions. The first and the second control device are each put into the deactivation state in which the execution of operating functions of the operating mode is prevented, preferably at least to a large extent. The first and the second control device are each put into the programming mode, during which the reversible deactivation state of each control device continues to prevail. The deactivation state of all control devices will be terminated after the respective data or sequencing controls have been entered in all control devices in the programming mode.

Each of the control devices is installed in the vehicle, and emits data by way of a data bus in its operating mode. Each of the control devices is preferably put into a reversible deactivation condition before the entering of data or of a sequencing control. A control device that is in the deactivation state preferably emits no or only a few data by way of the data bus, so that in the deactivation state, the total bandwidth of the data bus is available for the entering of data and sequencing controls into the control devices. The communication between the control devices of the vehicle will preferably only start again when all programming measures at the control devices to be programmed have been concluded and the deactivation condition of each control device, i.e. newly programmed and possibly not newly programmed control devices, is jointly canceled and the control devices return to their operating mode. As a result, it is avoided that error storage entries erroneously take place in the storage devices, which would occur if the control devices were to immediately return to the operating mode after their respective programming and the control devices were to communicate with one another by way of the data with not yet mutually adapted sequencing controls.

In an embodiment of the invention, it is provided that a control device that is in the deactivation state remains in the deactivation state after a restarting of the control device, for example, an unintentional restarting because of a voltage loss. As a result, particularly not defined operating states of the control devices are prevented after a failure.

In a further development of the invention, it is provided that at least one of the following operating functions is switched off in the deactivation state: automatic error storage, emission of messages or emergency running functions. This leads to a relieving of the data bus in favor of the programming of the control devices. The occurrence of supposed errors is prevented, whereby the programming can be carried out in a more undisturbed fashion.

In an embodiment of the invention, each of the first and the second control devices is provided with new data or with a completely or partially new sequencing control in the programming mode. These may be stored in a flash E-PROM of the corresponding control device. After the conclusion of the programming of all control devices, each of the first and the second control devices is put into its operating mode, which is preferably accompanied by a cancellation of the deactivation state. As a result of the joint cancellation of the deactivation state of all mutually communicating control devices and their largely simultaneous change to their operating mode, defined conditions are created in which all participating control devices communicate with one another by using their newly programmed data or their newly programmed sequencing controls.

This particularly prevents compatibility problems and erroneous confusing error storage entries into the concerned control devices.

In a further development of the invention, it is provided that the first and the second control device are put into the reversible deactivation state, the programming mode or the operating mode by a diagnostic device, particularly a control device tester, preferably after an authorization check, in a vehicle shop.

In addition, an aspect of the invention provides a motor vehicle having an on-board network which has at least a first and a second control device, data or sequencing controls being entered into the first and the second control device by the method described above. Furthermore, an aspect of the invention provides a control device in the on-board network of a vehicle into which data or sequencing controls are entered by the method described above. Another aspect of the invention provides a diagnostic device for the control devices of an on-board network of a motor vehicle, particularly a diagnostic tester, where the diagnostic device enters data or sequencing controls into at least a first and a second control device of a motor vehicle by means of the method described above.

### BRIEF DESCRIPTION OF THE DRAWING

The above and other aspects of the invention will become more apparent by describing in detail exemplary embodiments thereof with reference to the attached drawing, in which:

FIG. 1 is a flowchart illustrating a method according to exemplary embodiments of the invention.

### DETAILED DESCRIPTION OF EMBODIMENTS OF THE INVENTION

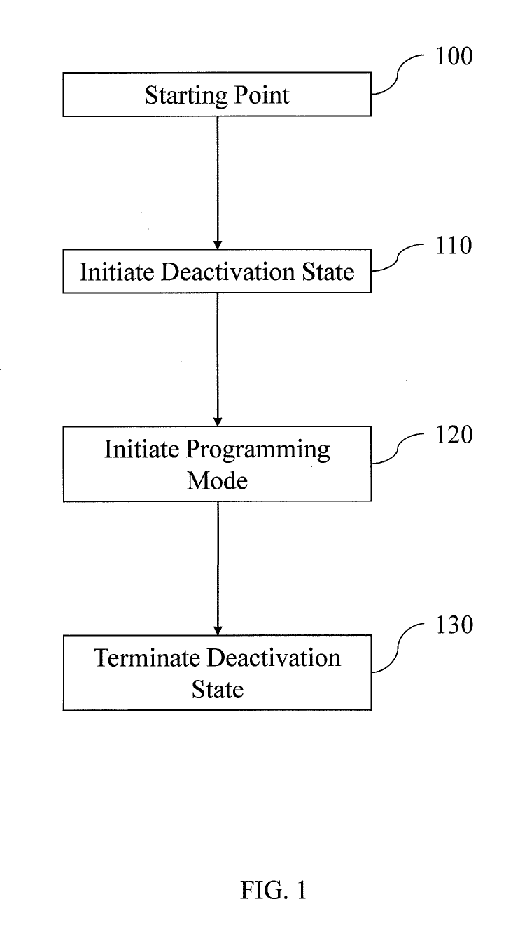

As shown in FIG. 1, at the starting point 100, respectively programmed control devices in an onboard network of a motor vehicle are in the operating mode of a so-called ApplicationDefaultSession “application-active” state, after their start or the start of their sequencing control. In this state, each control device has loaded the software required for its regular functions into the program memory and executes its application, such as control functions for the vehicle engine in the case of an engine control unit.

In order to carry out a new programming of one or more of these control devices, a diagnostic device or a so-called diagnostic tester is physically connected by way of a data connection with the corresponding control device. This connection is typically established by way of a central access, such as the so-called on-board diagnostic connection (OBD connection). This may be an Ethernet connection provided in the vehicle. The tester may be connected by way of one or more gateways with all control devices installed in the on-board network or with all on-board network users.

Subsequently, the tester will start with the vehicle-wide programming preparation such that, if possible, in the case of each control device, a reversible deactivation state provided according to embodiments of the invention will be initiated by the diagnostic tester (step 110). In the deactivation state, the automatic error storage is switched off and the communication in the on-board network is preferably reduced to a minimum in the case of all control devices. In the deactivation state, the sequencing control of the control device initiates that applicative messages or messages of the operating mode that are not part of the diagnosis will no longer be transmitted.

In order to cause the deactivation state, the tester preferably switches all control devices by means of a “DiagnosticSessionControl” command into the ApplicationExtendedDiagnosticSession and into a corresponding special mode for the reactivation state. In the special mode, the automatic error storage, the applicative messages and/or the emergency running functions may be switched off for minimizing the data traffic on the corresponding data bus of the vehicle. According to embodiments of the invention, it is provided that the special mode is persistent because of a corresponding programming of the sequencing control of each control device; i.e. each control device that is in the reactivation state or in the special mode will return to this state even after a voltage loss or a restarting of the on-board network and of the control devices.

In the next step, the tester transmits, for example, the “programming session” command, whereby the control device restarts preferably internally and automatically switches over to the so-called BootloaderProgrammingSession or the programming mode (step 120).

In the programming mode, the tester changes the content of one or more storage areas of the corresponding control device or of the corresponding control devices. This especially involves updated data and/or an updated sequencing control for the corresponding control device. After the programming operation, the control device will be restarted.

After its restarting, the respective control device will check, possibly after additional tests, whether the reversible deactivation state or special mode has been set. If so, the parameters continue to remain corresponding to the adjustments previously made by the tester in order to have optimal outline conditions for the measures at the control device. This means that, as long as the tester does not switch the control device over again, it will stay in its deactivation state or in its special mode without any problems and will not interfere with the programming of additional on-board network users.

In the on-board network composite, the tester will continue with the programming of additional control devices as described above. After all control devices to be programmed have been programmed or have been provided with new data and/or sequencing controls, the tester will cancel the deactivation state or the special mode; e.g., the flash mode that had previously been set to “ON” will be set to “OFF” (step 130). With the cancellation of the reactivation condition, the corresponding control devices are changed from the special mode to the operating mode. In their respective operating mode, the control devices will then again execute their operating functions by using possibly updated data and/or on the basis of a possibly updated sequencing control.

All control devices and thus also the transmission medium used for the programming will remain in the state optimal for the programming until the conclusion of the programming of all control devices. For example, the bandwidth available by way of the controller-area network (CAN) bus is maximal and is not narrowed by applicative messages. This reduces the danger of abortions during the programming and also reduces the total programming time.

As a result of the method of embodiments of the invention, the control devices will no longer erroneously switch to an emergency running operation, because it is now clarified by way of the special mode according to embodiments of the invention that the communication is failing because of the programming. This prevents damage that may occur when emergency running functions are triggered in the “dry state”, such as a scratched window as a result of a wiper function on the dry window, a burnt-out mirror heater, etc. It is only at a reasonable point in time that the control devices will attempt to take up the communication to other on-board network users. In this manner, errors are excluded that are a result of a not yet terminated overall programming operation. This lowers the cost of the analysis and elimination of errors.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for entering data into at least a first control device and a second control device of a motor vehicle, the method comprising the acts of:
providing each of the first control device and the second control device with a sequencing control that has a reversible deactivation state, a programming mode, and an operating mode with operating functions;
putting each of the first control device and the second control device into the deactivation state, during which execution of at least some of the operating functions of the operating mode is prevented;
putting each of the first control device and the second control device into the programming mode, while maintaining the deactivation state of each of the first control device and the second control device; and
terminating the deactivation state of all control devices after respective data have been entered into all control devices in the programming mode.

2. The method according to claim 1, wherein a control device that is in the deactivation state remains in the deactivation state after a restarting of the control device.

3. The method according to claim 2, wherein the restarting of the control device is an unintentional restarting due to a voltage loss.

4. The method according to claim 1, wherein at least one of the operating functions of automatic error storage, emission of messages, or emergency running function is switched off in the deactivation state.

5. The method according to claim 1, wherein during the programming mode, each of the first control device and the second control device is provided with new data or with a completely or partially new sequencing control, which are stored in at least one reprogrammable storage area of the respective control device.

6. The method according to claim 1, wherein after the programming of all of the control devices, each of the first control device and the second control device is put into its operating mode.

7. The method according to claim 6, wherein after the programming of all of the control devices, the deactivation state of the first control device and the second control device is cancelled.

8. The method according to claim 1, wherein the first control device and the second control device are put into the reversible deactivation state, the programming mode, or the operating mode by a diagnostic device in a vehicle shop.

9. The method according to claim 8, wherein the diagnostic device is a control device tester.

10. The method according to claim 8, wherein the first control device and the second control device are put into the reversible deactivation state, the programming mode, or the operating mode after an authorization check.

11. A vehicle comprising:
an on-board network comprising at least a first control device and a second control device, wherein data or sequencing controls are entered into the first control device and the second control device by:
providing each of the first control device and the second control device with a sequencing control that has a reversible deactivation state, a programming mode, and an operating mode with operating functions;
putting each of the first control device and the second control device into the deactivation state, during which execution of at least some of the operating functions of the operating mode is prevented;
putting each of the first control device and the second control device into the programming mode, while maintaining the deactivation state of each of the first control device and the second control device; and
terminating the deactivation state of all control devices after respective data have been entered into all control devices in the programming mode.

12. A control device in an on-board network of a vehicle, wherein data or sequencing controls are entered into the control device by:
providing each of the first control device and the second control device with a sequencing control that has a reversible deactivation state, a programming mode, and an operating mode with operating functions;
putting each of the first control device and the second control device into the deactivation state, during which execution of at least some of the operating functions of the operating mode is prevented;
putting each of the first control device and the second control device into the programming mode, while maintaining the deactivation state of each of the first control device and the second control device; and
terminating the deactivation state of all control devices after respective data have been entered into all control devices in the programming mode.

13. A diagnostic device for control devices of an on-board network of a motor vehicle, wherein the diagnostic device enters data or sequencing controls into at least a first control device and a second control device of the vehicle by:
providing each of the first control device and the second control device with a sequencing control that has a reversible deactivation state, a programming mode, and an operating mode with operating functions;
putting each of the first control device and the second control device into the deactivation state, during which execution of at least some of the operating functions of the operating mode is prevented;
putting each of the first control device and the second control device into the programming mode, while maintaining the deactivation state of each of the first control device and the second control device; and
terminating the deactivation state of all control devices after respective data have been entered into all control devices in the programming mode.
